(19) United States
(12) Patent Application Publication
(10) Pub. No.: US 2026/0328597 A1
(43) Pub. Date: Oct. 22, 2026

(54) Dual-parameter Fiber Optic Sensor Based on an Inclined Fiber for Temperature and Salinity Detection

(71) Applicant: Shandong Normal University, Jinan (CN)

(72) Inventors: Guoqiang Li, Jinan (CN); Jinghan Sun, Jinan (CN)

(21) Appl. No.: 19/709,533

(22) Filed: Jun. 16, 2026

(51) Int. Cl. G01D 5/353; G01K 11/3206; G01N 21/65

(52) U.S. Cl. CPC G01D 5/35316; G01K 11/3206; G01N 21/658

(57) ABSTRACT

The present invention discloses a tilted fiber Bragg grating (TFBG)-based dual-parameter optical fiber sensor for synchronous temperature and salinity detection, applicable to in-situ monitoring of marine and various saline liquid environments. The sensor integrates a D-shaped evanescent field enhancement window, a dielectric metasurface, a gold nanolayer for Surface-Enhanced Raman Scattering (SERS) hot spot generation, and a salinity-sensitive SERS functional layer on a single TFBG sensing region. The TFBG provides cladding-mode resonant spectral signals for salinity-related refractive index detection, while the anti-Stokes/Stokes Raman intensity ratio of the SERS functional layer achieves precise temperature measurement. Salinity is synergistically determined by TFBG spectral drift and characteristic Raman signal variation, with effective temperature compensation implemented to eliminate cross interference. The proposed structure enhances evanescent field coupling, ensures stable SERS signal output, and realizes high-sensitivity, anti-interference synchronous temperature-salinity detection, overcoming defects of traditional single-mode sensing structures.

### BACKGROUND OF THE INVENTION

Seawater temperature and salinity constitute core physical parameters characterizing marine environmental conditions. Temperature directly affects seawater density, acoustic propagation velocity, hydrodynamic movement, thermal exchange and aquatic ecological evolution; salinity reflects bulk ionic concentration, evaporation-precipitation balance, terrestrial river inflow, contaminant migration and fluid mixing status in aqueous environments. Therefore, developing high-sensitivity, long-term stable, field-deployable synchronous temperature-salinity measurement technology bears prominent industrial and environmental significance.

Conventional temperature and salinity measurement solutions mainly employ conductivity transducers, thermistors, refractive index sensors or electrochemical sensing probes. Though mature in laboratory application, such devices suffer critical drawbacks during long-term marine deployment including electrode polarization, electrochemical corrosion, biological fouling, particulate contamination and severe cross-parameter interference. Optical fiber sensors feature miniature dimension, immunity to electromagnetic interference, outstanding corrosion resistance, remote signal transmission capability and easy array integration, making them ideal for long-duration in-situ monitoring in marine and complicated liquid surroundings.

Tilted Fiber Bragg Gratings (TFBG) enable coupling of core modes to multiple cladding modes. Since cladding modes produce evanescent fields near the outer surface of the optical fiber, cladding-mode resonance peaks exhibit high sensitivity to variations in external refractive index. Changes in seawater salinity alter the refractive index of the surrounding liquid medium; accordingly, TFBG cladding modes are capable of salinity-related refractive index measurement. Nevertheless, detection relying solely on the drift of TFBG cladding-mode peak positions is still vulnerable to temperature cross-sensitivity, light source fluctuation, and disturbances arising from complex liquid environments, which limits detection accuracy and stability in practical marine monitoring applications.

Accordingly, there is an urgent need to develop a salinity sensing apparatus and a corresponding salinity sensing method that achieve structural isolation between dry and wet areas, realize efficient gate coupling at the circuit level, and maintain stable output signals under long-term immersion operating conditions.

Surface-Enhanced Raman Scattering (SERS) is a powerful detection technique that leverages localized surface plasmon resonance of metallic nanostructures to significantly amplify inherent Raman scattering signals. SERS technology not only greatly enhances the intensity of Raman spectral signals but also provides unique molecular fingerprint information for substance identification. Integrating a SERS functional layer with a TFBG optical fiber structure allows simultaneous acquisition of optical fiber spectral signals and Raman spectral signals on a single sensing probe. Such hybrid sensing architecture effectively increases detection dimensionality and substantially improves the anti-interference capability of marine environmental monitoring, overcoming the inherent limitations of conventional single-mode TFBG detection schemes.

Currently, existing fiber-optic SERS structures are commonly fabricated by directly depositing metallic nanoparticles or metallic thin films on the cylindrical surface of optical fibers. Due to the large curvature of the cylindrical fiber surface, uniform fabrication of micro-nano structures is difficult to achieve, resulting in unstable distribution of SERS hot spots and limited coupling efficiency between the fiber evanescent field and the SERS functional layer. These structural defects restrict the signal enhancement effect and detection repeatability of traditional fiber-SERS composite sensors in complex marine environments. Accordingly, there remains an urgent technical demand for a composite fiber temperature and salinity sensing structure that provides a flat processing area, enhanced evanescent field leakage, stable micro-nano structural framework, and multi-channel signal fusion capability.

### SUMMARY OF THE INVENTION

The present invention provides a dual-parameter fiber optic sensor based on a Tilted Fiber Bragg Grating (TFBG) optical fiber for temperature and salinity measurement. The sensor comprises a single-mode optical fiber, a tilted fiber Bragg grating inscribed in the single-mode optical fiber, a D-shaped window disposed in a sensing region of the tilted fiber Bragg grating, a metasurface arranged on the surface of the D-shaped window, a gold nanolayer deposited on the metasurface, and a Surface-Enhanced Raman Scattering (SERS) functional layer overlying the gold nanolayer.

In the disclosed structure, the TFBG is configured to couple core modes to cladding modes and generate cladding mode spectral signals that are highly sensitive to variations in external refractive index. The D-shaped window structure enables enhanced leakage of cladding mode evanescent fields within the window region while providing a flat, low-curvature platform for stable metasurface fabrication. The integrated metasurface functions to modulate localized optical fields, increase the effective light-matter interaction area, and optimize mode coupling efficiency. The gold nanolayer excites localized surface plasmon resonance and forms abundant SERS hot spots for signal amplification. The SERS functional layer further converts subtle variations in ambient temperature and seawater salinity into distinguishable Raman spectral signal changes, thereby realizing high-precision, anti-interference dual-parameter synchronous detection.

In the present invention, temperature detection is realized based on the intensity ratio between Raman anti-Stokes peaks and Stokes peaks. Anti-Stokes scattering originates from the excited state of molecular vibrations, and its intensity is strongly correlated with the thermal population of molecular vibrational energy levels, rendering it highly sensitive to temperature fluctuations. By acquiring the anti-Stokes peak and Stokes peak corresponding to the same Raman vibration mode and calculating the intensity ratio of the two peaks, accurate temperature information of the detection environment can be reliably acquired.

Salinity detection of the present invention is accomplished through two collaborative signal sources. The first signal source derives from the resonant peak shift of TFBG cladding modes, which responds to variations in external refractive index induced by seawater salinity changes. The second signal source corresponds to variations in the intensity, position, width, or intensity ratio of Raman characteristic peaks generated by the salinity-sensitive SERS functional layer, which reflects the influence of ionic strength changes on the local microenvironment of the salinity-sensitive layer and SERS hot spots. Based on the Raman-based temperature measurement results, temperature compensation is performed on both TFBG and SERS salinity signals, thereby achieving synchronous and decoupled high-precision detection of seawater temperature and salinity.

### BRIEF DESCRIPTION OF FIGURES

For a better understanding of the present invention, reference may be made to the following accompanying figures.

FIG. 1 is a schematic view showing the overall structure of the inventive sensor.

FIG. 2 is a schematic diagram illustrating a sensing region of the optical fiber sensing head.

FIG. 3 is a schematic diagram illustrating the structure of a metasurface and a SERS functional layer on the surface of a D-shaped window.

FIG. 4 is a schematic diagram illustrating the structure of a SERS functional layer and a porous protective layer.

### DETAILED DESCRIPTION OF THE INVENTION

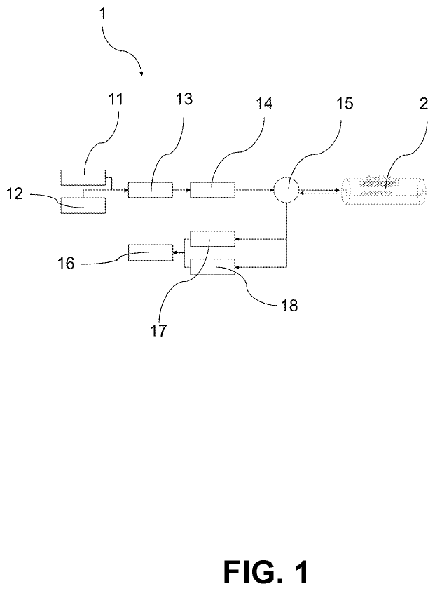

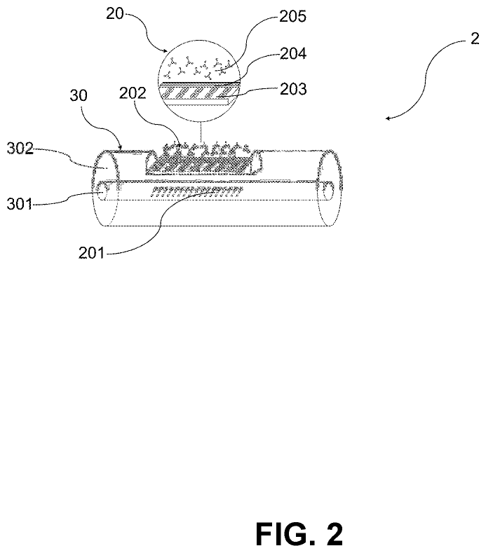

As shown in FIG. 1 and FIG. 2, the optical fiber sensor 1 comprises a tunable-wavelength laser 11, a single-wavelength laser 12, an optical switch 13, a polarization controller 14, an optical circulator 15, a data acquisition and analysis unit 16, an infrared-band spectrometer 17, a visible-band spectrometer 18, and an optical fiber sensing head 2. As illustrated in FIG. 2, the fiber sensing head 2 includes a single-mode optical fiber 30 and at least one fiber sensing unit 20. The single-mode optical fiber 30 is composed of an inner fiber core 301 and outer fiber cladding 302. The fiber sensing unit 20 comprises a tilted fiber Bragg grating 201, a D-shaped window 202, a metasurface 203, a gold nanolayer 204, a SERS functional layer 205, and a porous protective layer 206. The tunable-wavelength laser 11 serves as a demodulation light source for the tilted fiber Bragg grating 201, operating within the optical communication band ranging from 1510 nm to 1590 nm, with scanning range adjustable according to the actual resonant wavelength of the tilted fiber Bragg grating 201. The single-wavelength laser 12 is optionally set at 532 nm, 633 nm or 785 nm, among which the 785 nm excitation wavelength is preferred for seawater and complex fluid testing to suppress background fluorescence interference.

As illustrated in FIG. 2, the tilted fiber Bragg grating 201 is inscribed inside the fiber sensing unit 20 at an inclined angle relative to the central fiber axis to realize optical conversion from core modes to cladding modes. The tilted fiber Bragg grating 201 can be fabricated via ultraviolet phase mask lithography, femtosecond laser direct writing or alternative conventional fiber grating inscription techniques. The tilted fiber Bragg grating has a length of 5 mm to 30 mm, preferably 10 mm to 15 mm, and a tilt angle of 2° to 15°, preferably 6° to 10°. The tilted fiber Bragg grating 201 has two primary functions. First, the tilted fiber Bragg grating 201 couples incoming core modes into cladding modes. The electric field of the cladding modes distributes around the fiber cladding 302 and its outer surface, which enhances the influence of the surrounding medium on the optical spectrum. Meanwhile, the tilted fiber Bragg grating 201 reflects laser light to the metasurface 203, which further modulates the laser to enhance the interaction between the laser and the gold nanolayer 204. Second, the tilted fiber Bragg grating 201 generates multiple cladding-mode resonant peaks. These resonant peaks are highly sensitive to variations in the refractive index of the surrounding liquid, and thus can be used for salinity-related refractive index detection. Cladding-mode peaks of the tilted fiber Bragg grating 201 are adopted for salinity testing and refractive index response analysis after temperature correction, whereas temperature data is obtained from the intensity ratio between anti-Stokes Raman signal and Stokes Raman signal.

A D-shaped window 202 is fabricated on one lateral side of the fiber segment with inscribed tilted fiber Bragg grating 201 to act as the primary optical field coupling region. The D-shaped window 202 is formed by partial removal of lateral cladding material to create a substantially flat fiber sidewall, extending axially to fully cover the sensing length of the tilted fiber Bragg grating 201. Fabrication routes for the D-shaped window 202 include mechanical side polishing, precision grinding, wet chemical etching, laser ablation, or any combination of the foregoing processes. The D-shaped window 202 reduces residual cladding thickness to enhance outward evanescent field leakage of TFBG-induced cladding modes.

Additionally, the flat surface of D-shaped window 202 provides uniform processing substrate for consistent patterning and gold deposition of the metasurface 203, eliminating structural nonuniformity triggered by large cylindrical fiber curvature and improving periodicity, coverage uniformity and fabrication repeatability of the metasurface 203. Residual cladding thickness of the D-shaped window 202 is optimized to balance evanescent field intensity and mechanical durability; thinner residual cladding generates stronger evanescent leakage yet sacrifices mechanical strength and transmission stability, so final window depth is selected based on TFBG resonant loss, targeted detection sensitivity and packaging requirements.

The metasurface 203 is manufactured on the planar surface of D-shaped window 202, constructed from at least one microstructure selected from glass nanopillar array, glass nanohole array, glass microlens array, glass grating array, quartz nano-groove array and silicon dioxide nano-protrusion array for localized near-field modulation. The metasurface is made of quartz, silicon dioxide, borosilicate glass or other transparent dielectric materials to secure structural stability and corrosion resistance.

The metasurface 203 is processable via reactive ion etching, femtosecond laser micromachining, nanoimprint lithography, electron beam lithography, dry etching, wet etching or silica thin-film deposition. After metasurface formation, a gold nanolayer 204 with thickness ranging from 5 nm to 50 nm is deposited to form SERS-active gold nanostructure, wherein nanoscale gaps between separated gold domains form localized plasmonic SERS hot spots. In an alternative embodiment, the metasurface is assembled by immobilizing silica nanoparticles or glass microsphere array onto the D-shaped window followed by gold coating, with inter-particle gaps functioning as SERS hot-spot domains for Raman enhancement.

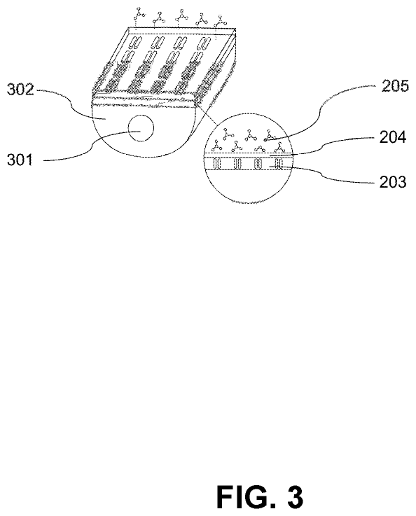

With reference to FIG. 3, the gold nanolayer 204 covers the metasurface 203, and a SERS functional layer 205 is coated atop the gold nanolayer 204. The SERS functional layer 205 consists of Raman reporter molecules, salinity-sensitive functional polymers or composite thereof, which converts local environmental variations induced by temperature and salinity change into distinguishable Raman spectral shifts. Suitable Raman reporter molecules include 4-mercaptobenzoic acid, 4-aminothiophenol or other compounds with characteristic Raman peaks capable of stable chemical bonding onto gold surfaces via covalent linkage. The salinity-sensitive functional materials are selected from polyacrylic acid, poly (allylamine hydrochloride), polystyrene sulfonate, thin hydrogel or other ion-strength-responsive polymers, which are either overlaid outside reporter molecules or blended together to form integrated composite SERS coating. Salinity fluctuation alters spacing, molecular orientation, local dielectric constant and electromagnetic coupling between reporter molecules and SERS hot spots, leading to measurable variation on intensity, peak position, spectral width or relative peak ratio of collected SERS spectra.

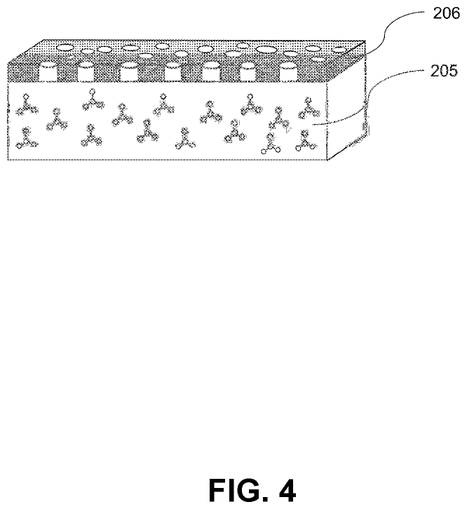

As shown in FIG. 4, a porous protective layer 206 is arranged on the outer surface of SERS functional layer 205, which is composed of porous silica, hydrophilic antifouling polymer or other water-permeable macromolecular materials. The porous protective layer 206 provides three core functions: first, mechanically shield the underlying metasurface 203, gold nanolayer 204 and SERS functional layer 205 against seawater erosion, contamination and exfoliation; second, permit free permeation of water molecules and salt ions to guarantee normal salinity-responsive performance of the inner functional layer; third, prevent coverage of gold SERS hot spots by organic contaminants and biological films.

When ambient temperature or salinity varies, resonant wavelength of tilted fiber Bragg grating 201 shifts. Peak position is extracted via peak fitting, valley fitting, Gaussian fitting, Lorentzian fitting or peak-tracking algorithm, and resultant wavelength drift serves as detection signal corresponding to salinity-induced refractive index change. Upon laser irradiation on the D-shaped window 202 region, the metasurface 203 modulates local optical field to strengthen light coupling into the gold nanolayer 204, where localized surface plasmon resonance is excited to enhance Raman signals generated from the overlying SERS functional layer 205. Dual spectrometers synchronously collect Stokes and anti-Stokes spectra: the intensity ratio between anti-Stokes and Stokes peaks is calculated for temperature quantification, and characteristic peak intensity variation of salinity-sensitive polymers is taken as auxiliary salinity signal after temperature compensation.

Optionally, the fiber sensing head 2 is equipped with two or more fiber sensing units 20 having differentiated structural parameters for mutual cross-verification and improvement of measurement accuracy.

The fiber sensing head 2 can be manufactured through the following steps:
Step 1: Select single-mode optical fiber 30, and inscribe tilted fiber Bragg grating 201 at predetermined fiber segment via ultraviolet phase mask writing or femtosecond laser direct writing. Post-inscription transmission spectrum testing verifies compliance of cladding-mode peak position and spectral loss depth with design specifications.
Step 2: Fabricate D-shaped window 202 on one lateral side of TFBG-bearing fiber via mechanical side polishing, precision grinding, laser ablation or wet cladding etching; processing depth is precisely controlled to balance evanescent field leakage and mechanical robustness.
Step 3: Form metasurface 203 on D-shaped window 202 surface: Option 1: Pre-deposit silica or quartz thin film, then pattern nanopillar, nanohole, nano-groove or microlens array by nanoimprinting, etching, femtosecond laser processing or electron beam lithography; Option 2: Fix silica nanoparticles or glass microspheres onto the planar D-shaped substrate to construct particle-assembled metasurface.

Step 4: Deposit gold nanolayer 204 of 5 nm to 50 nm thickness over the metasurface 203 by magnetron sputtering, thermal evaporation, electron beam evaporation, chemical deposition or seed-mediated growth. Post-deposition thermal annealing, plasma treatment or mild chemical etching generates gold nanoislands, nanogaps or roughened gold surface to increase SERS hot-spot density.

Step 5: Immerse gold-coated sensing probe into Raman reporter solution to immobilize thiol-type reporter molecules onto gold nanolayer via chemically bonding; subsequently coat salinity-sensitive polymer or hydrogel to form integrated SERS functional layer 205.

Step 6: Form outer porous protective layer 206 on the outer surface of SERS functional layer 205, with the porous structure enabling water and ion permeation while delivering antifouling and mechanical protection; complete final processing of the sensing head via cleaning, drying, encapsulation and calibration.

1. An optical fiber sensor for synchronous temperature and salinity measurement, comprising:
a tunable-wavelength laser, a single-wavelength laser, an optical switch, a polarization controller, an optical circulator, a data acquisition and analysis device, an infrared-band spectrometer, a visible-band spectrometer, and an optical fiber sensing head;
wherein the optical fiber sensing head includes a single-mode optical fiber and at least one fiber sensing unit;
the single-mode optical fiber is constituted by an inner fiber core and an outer fiber cladding;
the fiber sensing unit comprises a tilted fiber Bragg grating;
a D-shaped window is formed on one side of the tilted fiber Bragg grating;
a metasurface is disposed on a surface of the D-shaped window;
a gold nanolayer is deposited on a surface of the metasurface;
a surface-enhanced Raman scattering (SERS) functional layer is arranged on an outer surface of the gold nanolayer;
the tilted fiber Bragg grating is configured to couple core optical modes into cladding modes such that the cladding modes produce evanescent fields interacting with surrounding liquid within the D-shaped window;
the D-shaped window is structured to enhance outward leakage of evanescent field of the cladding modes;
the metasurface is configured to modulate localized optical field distribution inside the D-shaped window;
the gold nanolayer is constructed to form a plurality of localized surface plasmon SERS hot spots;
the tilted fiber Bragg grating outputs cladding-mode resonant peak spectral signals;
the SERS functional layer generates Stokes scattering signals, anti-Stokes scattering signals and salinity-related Raman scattering signals;
ambient temperature is determined based on an intensity ratio of the anti-Stokes scattering signal to the Stokes scattering signal, and ambient salinity is measured jointly from the cladding-mode resonant peak signal and the salinity-related Raman scattering signal.

2. The optical fiber sensor of claim 1, wherein the tilted fiber Bragg grating has a length of 5 mm to 30 mm and a tilt angle of 2° to 15° relative to fiber central axis.

3. The optical fiber sensor of claim 1, wherein the D-shaped window is formed by at least one process selected from mechanical side polishing, precision grinding, wet chemical etching and laser micromachining.

4. The optical fiber sensor of claim 1, wherein the metasurface includes at least one structure selected from glass nanopillar array, glass nanohole array, glass microlens array, glass grating array, quartz nano-groove structure and silicon dioxide nano-protrusion structure.

5. The optical fiber sensor of claim 1, wherein the metasurface is made of a transparent dielectric material selected from quartz, silicon dioxide and borosilicate glass.

6. The optical fiber sensor of claim 1, wherein the gold nanolayer has a thickness of 5 nm to 50 nm.

7. The optical fiber sensor of claim 1, wherein the gold nanolayer is configured as one selected from continuous gold film, semi-continuous gold film, gold nanoisland layer, gold nanoparticle coating and gold plating structure with inherent nanoscale gaps.

8. The optical fiber sensor of claim 1, wherein the SERS functional layer includes Raman reporter molecules chemically bonded onto the outer surface of the gold nanolayer.

9. The optical fiber sensor of claim 1, wherein the SERS functional layer further comprises salinity-sensitive functional material.

10. The optical fiber sensor of claim 1, further comprising a porous protective layer attached on the outer surface of the SERS functional layer.
